(19) United States
(12) Patent Application Publication
(10) Pub. No.: US 2005/0206828 A1
(43) Pub. Date: Sep. 22, 2005

(54) Electroluminescent display device and method for manufacturing the same

(76) Inventors: Sun-Youl Lee, Suwon-si (KR); Kyoung-Do Kim, Suwon-si (KR)

Correspondence Address: MCGUIREWOODS, LLP, 1750 TYSONS BLVD, SUITE 1800, MCLEAN, VA, 22102, US

(21) Appl. No.: 11/079,072

(22) Filed: Mar. 15, 2005

(30) Foreign Application Priority Data
Mar. 20, 2004 (KR) 10-2004-0019125

(51) Int. Cl. G02F 1/1345

(52) U.S. Cl. 349/149

(57) ABSTRACT

An electroluminescent (EL) display device, and a method for manufacturing the same, including a display region, which is formed on a substrate and includes a first electrode layer, a second electrode layer, and an emission portion between the first electrode layer and the second electrode layer and a pad portion, which includes a terminal and is located outside the display region. A recess for accommodating terminals of an electric element is formed in a surface of the substrate, and the terminal is located in the recess.

### CROSS REFERENCE TO RELATED APPLICATION

This application claims priority to and the benefit of Korean Patent Application No. 10-2004-0019125, filed on Mar. 20, 2004, which is hereby incorporated by reference for all purposes as if fully set forth herein.

### BACKGROUND OF THE INVENTION

1. Field of the Invention

The present invention relates to a display such as an electroluminescent (EL) display, and more particularly, to an EL display including a pad portion that has a structure that may strengthen the adhesion of an electrical element to a substrate, and a method for manufacturing the same.

2. Discussion of the Background

Flat panel displays (FPDs), such as liquid crystal displays (LCDs), organic light emitting displays (OLEDs), and inorganic light emitting displays (ILEDs), may be categorized as passive matrix (PM) and active matrix (AM) types, depending on how they are driven. In a PM type display, anodes and cathodes are typically arranged in columns and rows, respectively. A row driving circuit may sequentially output a scanning signal to each row of cathodes, and a column driving circuit may output a data signal to each pixel in that row. On the other hand, an AM type display controls the signal input to each pixel using a thin film transistor (TFT), which allows it to display a higher bandwidth signal. Hence, AM displays are commonly used for displaying moving pictures.

Generally, an OLED includes an emission layer (EML), which comprises an organic material between an anode and a cathode. As anode and cathode voltages are applied to the anode and the cathode, respectively, holes injected from the anode are transported to the EML via a hole transport layer, and electrons injected from the cathode are transported to the EML via an electron transport layer. The holes recombine with the electrons in the EML, thereby producing excitons. As the excitons change from an excited state to a ground state, fluorescent molecules in the EML emit light to generate an image. The EML of a full color OLED includes pixels emitting red (R), green (G), and blue (B) light.

FIG. 1A is a plan view showing a conventional FPD, particularly an OLED. The OLED may include a display region 10, which is comprised of pixels and located on a surface of a substrate 1 of FIG. 1B, and a pad portion 20, which is located adjacent to at least one side of the display region 10.

FIG. 1B is a cross-sectional view taken along line A-A of FIG. 1A. As FIG. 1B is shows, the pad portion 20 may include terminals 2, which are formed on a surface of a substrate 1, and a horizontal driving circuit portion 14, such as a chip on glass (COG) or flexible printed circuit (FPC), located over the terminals 2. An anisotropic conductive film (ACF) 15 may be interposed between the terminals 2 and the horizontal driving circuit portion 14, which may be compressed to attach the horizontal driving circuit portion 14 to the substrate 1. However, as shown in FIG. 1C, which is a partial exploded view of the encircled area of FIG. 1B, since the terminals 2 protruding from the substrate 1 may align with terminals 14a protruding from the horizontal driving circuit portion 14, the ACF 15 may only make contact in the area as illustrated by the dotted lines, and not between the terminals. Even if the ACF 15 contacts other areas adjacent to the protruding terminals 2 and 14a, non-contact areas may still remain due to the protruding shapes of the terminals 2 and 14a.

In order to improve the ease of carrying and operating FPDs, especially EL displays, designs have recently relied on the substrate's flexibility. However, in a conventional display device, when the substrate bends, external electrical connections may separate from the substrate.

Korean Patent Laid-open Publication No. 1999-31984 discloses an LCD panel having an opening region designed to prevent electrical elements from separating from the substrate when the substrate bends.

Also, Korean Patent Laid-open Publication No. 1997-13000 discloses a method of mounting an integrated circuit (IC) chip on a panel. The method comprises forming pad patterns on the IC chip, forming an insulator on the IC chip to open the pad patterns, adhering an ACF having a protective layer on the pad patterns and the insulator, heating the ACF through the pad patterns, patterning the ACF by eliminating some portions of the ACF that are not located on the pad patterns, aligning and conjugating the patterned ACF of the IC chip and pad portions of a glass panel, and curing the patterned ACF.

In these cases, however, although a pad portion may be structured to prevent short-circuiting between adjacent terminals when the substrate is bonded to an electrical element, it may be difficult to reliably maintain adhesion due to substrate bending.

### SUMMARY OF THE INVENTION

The present invention provides an electroluminescent (EL) display device that may have improved adhesion between a substrate and an electrical element, while reliably maintaining an electrical connection between pad terminals and terminals of the electrical element.

Additional features of the invention will be set forth in the description which follows, and in part will be apparent from the description, or may be learned by practice of the invention.

The present invention discloses an electroluminescent display device comprising a substrate, a display region formed on the substrate and including a first electrode layer, a second electrode layer, and an emission portion between the first electrode layer and the second electrode layer. A pad portion having a terminal is located outside the display region. A recess is formed in a surface of the substrate, and the terminal is located in the recess.

The present invention also discloses an electroluminescent display device comprising a substrate, a display region formed on the substrate and including a first electrode layer, a second electrode layer, an emission portion located between the first electrode layer and the second electrode layer, and a thin film transistor (TFT) coupled with the first electrode layer. A pad portion has a terminal and is located outside the display region. A layer extending from the display region to the pad portion has a recess, and the terminal is located in the recess.

The present invention also discloses a method for manufacturing an electroluminescent display device comprising a display region, which is formed on a substrate and includes a first electrode layer, a second electrode layer, and an emission portion located between the first electrode layer and the second electrode layer, and a pad portion, which includes a terminal and is located outside the display region, the method comprising forming the pad portion. Herein, forming the pad portion comprises forming a recess in a surface of the substrate, and forming the terminal in the recess.

The present invention also discloses a method for manufacturing an electroluminescent display device comprising a display region, which is formed on a substrate and includes a first electrode layer, a second electrode layer, an emission portion located between the first electrode layer and the second electrode layer, and a thin film transistor (TFT) coupled with the first electrode layer, and a pad portion, which includes a terminal and is located outside the display region, the method comprising forming the pad portion. Herein, forming the pad portion comprises forming a layer extending from the display region to the pad portion, forming a recess in the layer, and forming the terminal in the recess.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1A is a plan view showing a conventional organic light emitting display (OLED) device.

FIG. 1B is a cross-sectional view taken along line A-A of FIG. 1A.

FIG. 1C is a partial exploded view showing the encircled region of FIG. 1B.

FIG. 2A is a plan view showing an OLED according to an exemplary embodiment of the present invention.

FIG. 2B is a partial exploded view of FIG. 2A.

FIG. 2C is a cross-sectional view taken along line I-I′ of FIG. 2B.

FIG. 2D is a cross-sectional view taken along line C-C of FIG. 2A.

FIG. 2E and FIG. 2F are cross-sectional views showing a process of attaching a pad portion to an electrical element according to an exemplary embodiment of the present invention.

FIG. 2G and FIG. 2H are cross-sectional views showing a pad portion according to another exemplary embodiment of the present invention.

FIG. 3A and FIG. 3B are cross-sectional views showing a process of attaching a pad portion to an electrical element according to another exemplary embodiment of the present invention.

FIG. 3C and FIG. 3D are cross-sectional views showing a pad portion according to another exemplary embodiment of the present invention.

### DETAILED DESCRIPTION OF THE ILLUSTRATED EMBODIMENTS

Hereinafter, exemplary embodiments of the present invention will be described in detail with reference to the attached drawings.

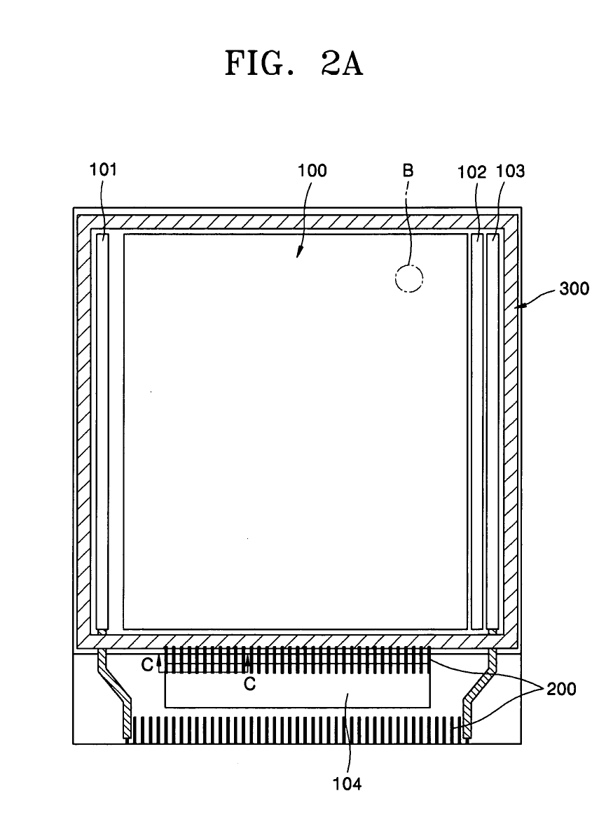

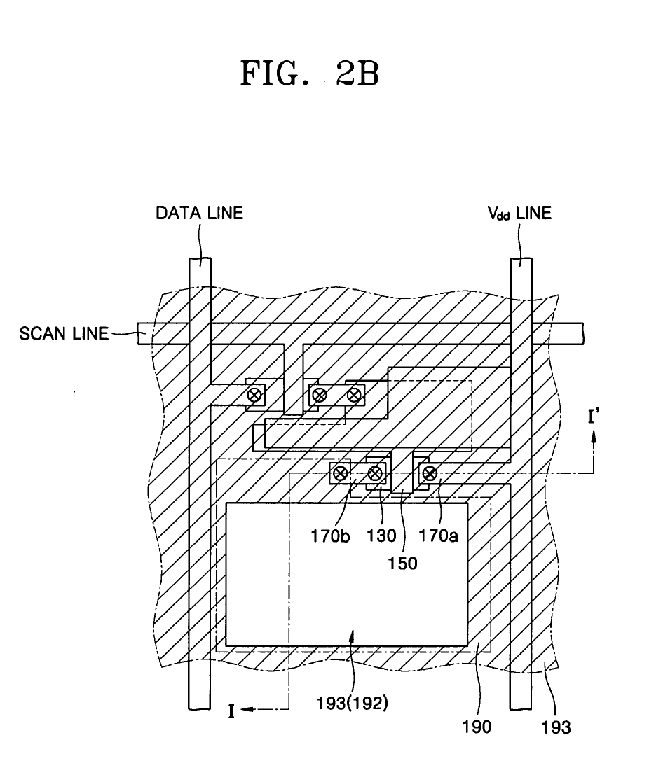

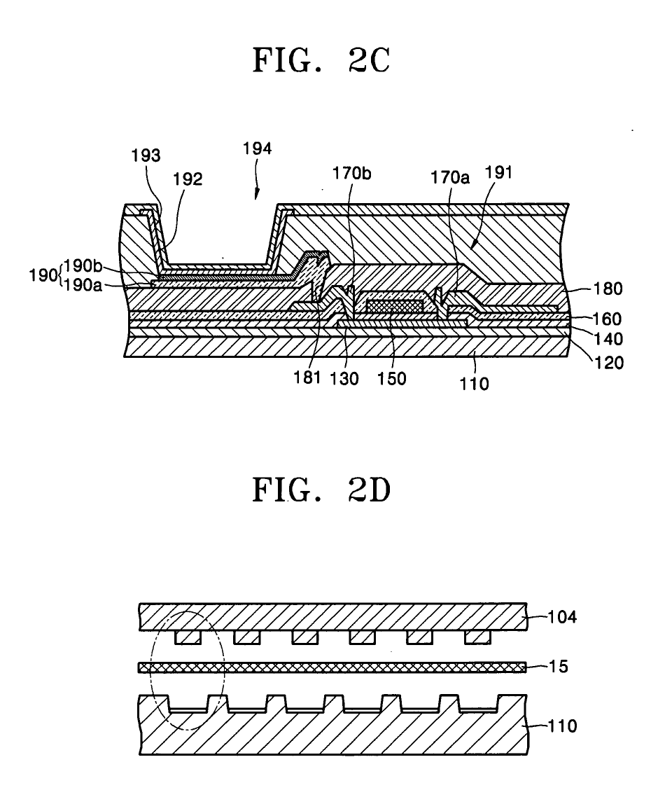

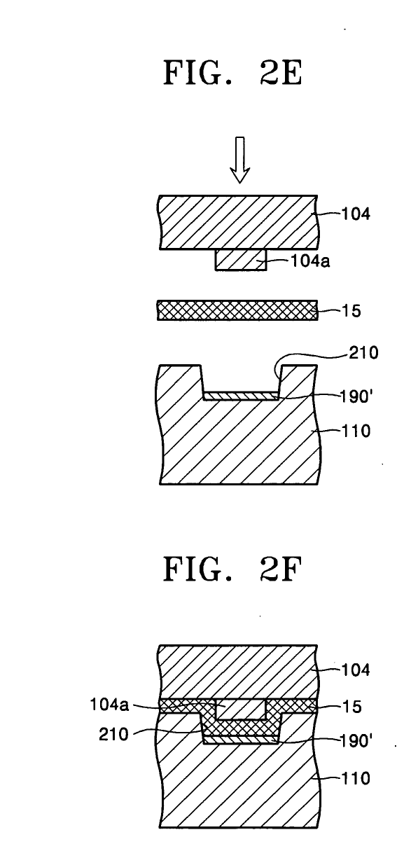

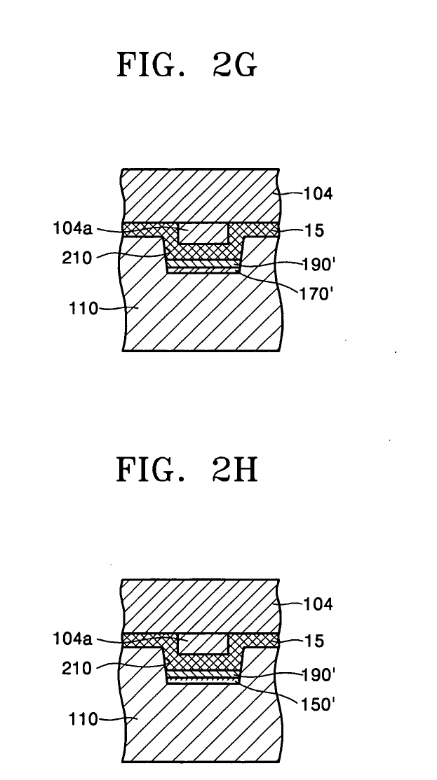

FIG. 2A is a plan view showing an electroluminescent (EL) display device according to an exemplary embodiment of the present invention, FIG. 2B is a partial exploded view of area B of FIG. 2A, and FIG. 2C is a cross-sectional view taken along line I-I′ of FIG. 2B.

Referring to FIG. 2A, FIG. 2B and FIG. 2C, the EL display includes a display region 100, comprising one or more pixels 194 formed on a surface of a substrate 110, and a pad portion 200, which includes one or more terminals on at least one edge of the display region 100.

A sealing portion 300 may surround and seal the display region 100. Electrode power supply lines 101 and 103 and driving power supply lines Vdd LINE may be formed within a sealing region defined by the sealing portion 300. In some cases, a vertical driving circuit portion 102 may also be located in the sealing portion 300. The electrode power supply lines 101 and 103 may be coupled with a second electrode layer 193 of the display region 100, and the driving power supply lines Vdd LINE may be coupled with a source electrode 170a of a thin film transistor (TFT) that applies an electric signal to a first electrode layer 190 of pixels 194. The vertical driving circuit portion 102 applies a scanning signal to the respective pixels of the display region 100. A horizontal driving circuit portion 104, which applies a data signal to the pixels of the display region 100, may be located in the pad portion 200. The layout of interconnections and circuits shown in FIG. 2A is exemplary, and the present invention is not limited thereto.

Further, while FIG. 2B shows a pixel including two TFTs and a capacitor, the present invention is not limited thereto.

Referring to FIG. 2C, a buffer layer 120 may be formed on a surface of a substrate 110. The buffer layer 120 may be formed of SiO₂, and it may be about 3,000 Å thick.

A semiconductor active layer 130 may then be formed on a surface of the buffer layer 120. The semiconductor active layer 130 may be an amorphous silicon or polysilicon layer. However, the semiconductor active layer 130 may be formed of other various materials. Although not specifically shown in the drawings, the semiconductor active layer 130 includes a channel region and source and drain regions, which may be doped with an n⁺-type or p⁺-type dopant.

A gate electrode 150 may be formed on a gate insulating layer 140. When a switching TFT is turned on by a scan signal applied to a scan line, signals from a data line output via a capacitor to the gate electrode 150 determine whether or not the channel region conducts, thereby connecting the source and drain regions of the semiconductor active layer 130 to each other. The gate electrode 150 may be formed of a material such as MoW. A gate insulating layer 140, which may be formed of SiO₂ and may be interposed between the semiconductor active layer 130 and the gate electrode 150, may be deposited using plasma-enhanced chemical vapor deposition (PECVD) or other like methods.

An interlayer 160 may be formed on the gate electrode 150, and it may comprise a single or double layer of SiO₂ or SiN_{X}. A source electrode 170a and a drain electrode 170b may be formed on the interlayer 160. The source and drain electrodes 170a and 170b may be coupled with the source and drain regions, respectively, of the semiconductor active layer 130 via contact holes formed in the interlayer 160 and the gate insulating layer 140.

A protective layer 180, which may include a passivation layer and/or a planarization layer, may be formed on the source and drain electrodes 170a and 170b to protect and/or planarize the TFT below. The protective layer 180 may have various structures. For example, it may be formed of an inorganic or organic material. Also, it may be a single or double layer including a SiN_{X} lower layer and an organic upper layer formed of benzocyclobutene (BCB), acryl, or other like materials. Further, the protective layer 180 may be a multiple layer formed of inorganic or organic materials.

A first electrode 190 may be formed on a surface of the protective layer 180, and one terminal of the first electrode layer 190 may be coupled with the drain electrode 170b through a via hole 181 formed in the protective layer 180. An inorganic or organic light emitting portion may be formed on a surface of the first electrode layer 190.

An emission portion 192, which may be formed of a low-molecular or high-molecular organic material layer, may be formed on a surface of a pixel defining layer 191 and on a surface of the first electrode 190 exposed by an opening in the pixel defining layer. If the emission portion 192 is formed of a low-molecular organic material layer, it may be formed having at least one of a hole injection layer (HIL), a hole transport layer (HTL), an emission layer (EML), an electron transport layer (ETL), and an electron injection layer (EIL) by using various organic materials, such as copper phthalocyanine (CuPc), N,N′-Di (naphthalene-1-yl)-N,N′-diphenyl-benzidine (NPB), and tris-8-hydroxyquinoline aluminum (Alq3). These low-molecular organic material layers may be deposited using a vacuum evaporation method.

If the emission portion 192 is formed of a high-molecular organic material layer, it may include an HTL and an EML. The HTL may be formed of PEDOT, and the EML may be formed of a high-molecular organic material, such as poly-phenylenevinylene (PPV) and polyfluorene. The HTL and EML may be deposited by screen printing or inkjet printing.

A second electrode layer 193 may be deposited on the entire the display region 100, or a part of it, including at least the surface of the emission portion 192. The second electrode layer 193 may be coupled with the electrode power supply lines 101 and 103, which are located outside the display region 100.

FIG. 2D, FIG. 2E and FIG. 2F, which are cross-sectional views taken along line C-C of FIG. 2A, illustrate terminals of the pad portion 200, which are electrically coupled with an electrical element, such as an FPC or a COG. A recess 210 is formed in a surface of the substrate 10 in the pad portion 200. A terminal of the pad portion 200 may be located in the recess 210. For example, as FIG. 2D, FIG. 2E and FIG. 2F show, the terminal may be located on the bottom of the recess 210. The terminals of the pad portion 200 may be formed of various conductive layers of the display region 100. The recess 210 may be formed using a conventional method such as photolithography, where the recess' depth may be controlled by varying the type and concentration of an etchant.

For example, as FIG. 2E shows, the terminals of the pad portion 200 may be formed using the same layer 190′ as the first electrode layer 190. Hence, the terminals may be formed at the same time as the first electrode layer 190, which may have various shapes. For example, as FIG. 2C shows, with a front surface light emitting type, the first electrode layer 190 may be a double layer including a thin reflection electrode 190a formed of Al, AlNd, Mg:Ag, or an alloy thereof, and a transparent metal oxide layer 190b formed of ITO or IZO. On the other hand, in the case of a rear surface light emitting type, the first electrode layer 190 may be a single layer formed of a transparent metal oxide layer having a large work function, such as an ITO layer or an IZO layer. Accordingly, the layer 190′ may be wholly or partially the same as the first electrode layer 190. Hence, the layer 190′ may include one or more layers. However, for ease of manufacture, the terminals of the pad portion 200 may include any or all of the layers constituting the first electrode layer 190. However, the present invention is not limited thereto, and the terminals of the pad portion 200 may alternatively be formed at the same time as the second electrode layer 193, which may also be formed as a single or double layer.

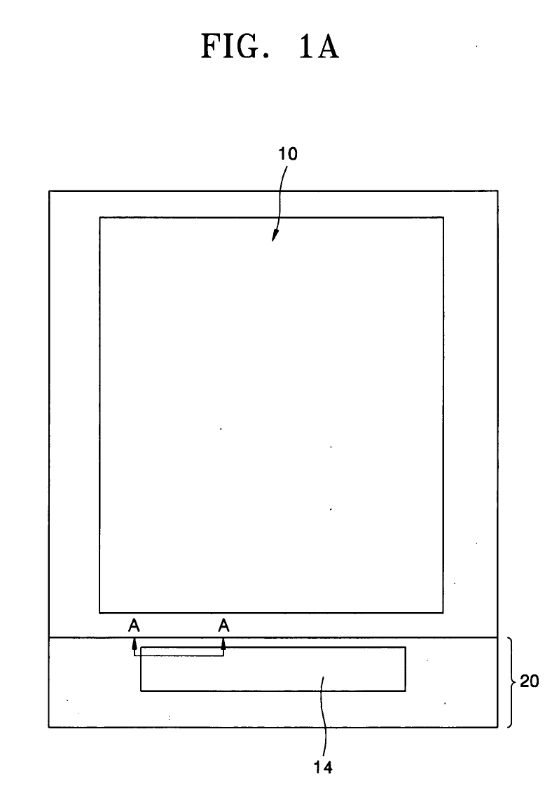

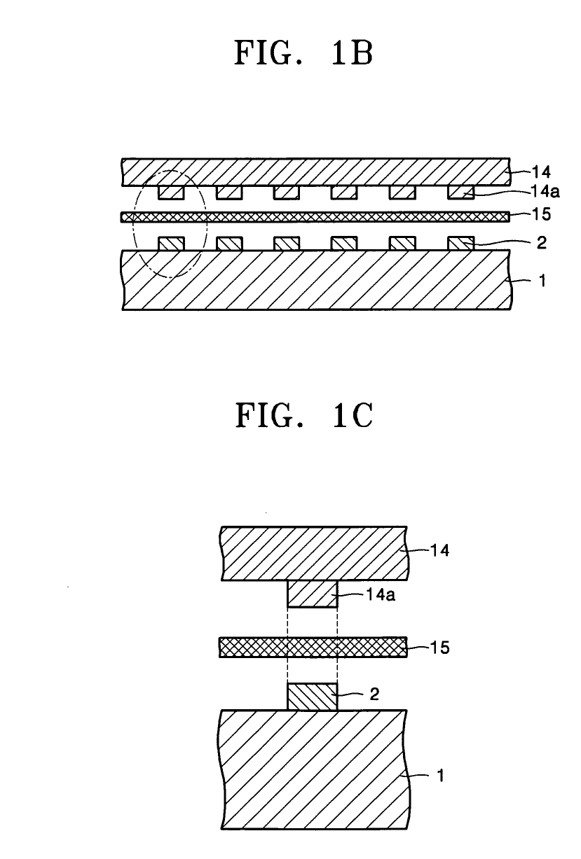

FIG. 2E is an exploded view showing the encircled portion of FIG. 2D. Referring to FIG. 2E, the substrate 110 may have the recess 210, and the same layer 190′ (i.e., a terminal conductive layer for the pad portion 200) as the first electrode layer 190 may be formed on the recess' bottom surface. An ACF 15 may be interposed between the horizontal driving circuit portion 104 and the substrate 110. Applying an external force to the upper and lower structures attaches the horizontal driving circuit portion 104 to the substrate 110, as shown in FIG. 2F. Simultaneously, a terminal 104a, formed beneath the horizontal driving circuit portion 104, may be coupled with the terminal conductive layer 190′ located on the bottom surface of the recess 210. Thus, an electric signal may be transmitted between the horizontal driving circuit portion 104 and the EL display through the ACF. Compared to the conventional case shown in FIG. 1C, the contact area between the horizontal driving circuit portion 104 and the EL display substrate 110 may be significantly increased, thereby enhancing adhesion and making separation difficult even if the substrate 110 bends.

In the above-described embodiment, although the same layer 190′ as the first electrode layer 190 may be used as a pad terminal portion, the present invention is not limited thereto. For example, as FIG. 2G and FIG. 2H show, a terminal conductive layer for forming terminals of the pad portion may be formed of one or more layers, including an upper terminal conductive layer and a lower terminal conductive layer. Specifically, referring to FIG. 2G, the same layer 170′ as the source and drain electrodes 170a and 170b (i.e., the layer 170′ formed at the same time as the source and drain electrodes 170a and 170b) may form the lower terminal conductive layer for the terminals of the pad portion. The same layer 190′ as the first electrode layer 190 may subsequently form the upper terminal conductive layer. Alternatively, as FIG. 2H shows, the same layer 150′ as the gate electrode 150 (i.e., the layer 150′ formed at the same time as the gate electrode 150) may form the lower terminal conductive layer. The same layer 190′ as the first electrode layer 190 may subsequently form the upper terminal conductive layer.

Meanwhile, according to another exemplary embodiment, a recess that interlocks with terminals of an electric element, such as a COG, may be formed in one or more insulating layers, such as a protective layer extending from the display region 100.

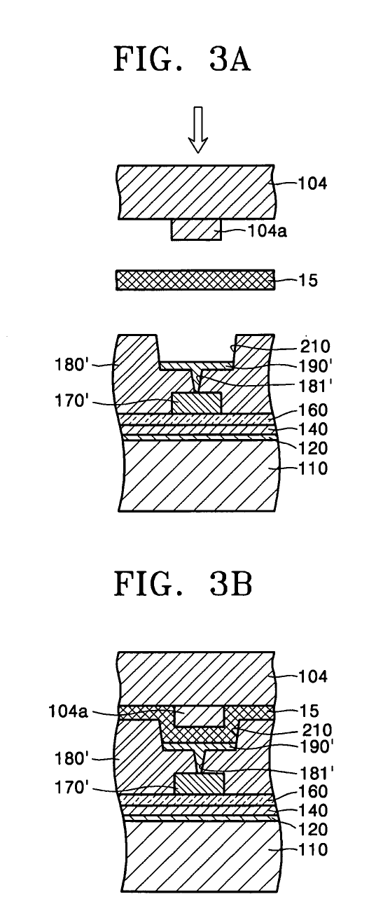

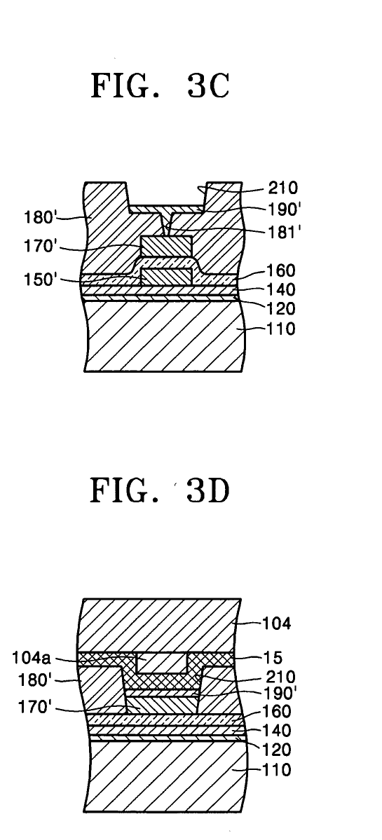

FIG. 3A is a cross-sectional view along line C-C of FIG. 2A according to an exemplary embodiment of the present invention. Referring to FIG. 3A, the substrate 110 having a pad portion is shown in a lower portion of the drawing, and the horizontal driving circuit portion 104, such as a COG, having the terminal 104a is shown in the drawing's upper portion. The buffer layer 120, the gate insulating layer 140, and the interlayer 160 may extend from the display region 100 to the pad portion 200 on a surface of the substrate 110. The same layer 170′ as the source and drain electrodes 170a and 170b may be formed as a lower terminal conductive layer on a surface of the interlayer 160, and a protective layer 180′ may be formed on the layer 170′.

A recess 210, which accommodates the terminal 104a of the horizontal driving circuit portion 104, may be formed in a surface of the protective layer 180′. The recess 210 may be formed simultaneously with the via hole 181 of FIG. 2C, which connects the first electrode layer 190 to the drain electrode 170b, or it may be formed using an additional process.

The same layer 190′ as the first electrode layer 190 may be formed on the bottom surface of the recess 210 as the upper terminal conductive layer. The layer 190′ (i.e., the upper terminal conductive layer) may be coupled with the layer 170′ (i.e., the lower terminal conductive layer) through the via hole 181′ formed in the protective layer 180′.

An ACF 15 and the horizontal driving circuit portion 104 may then be stacked on the substrate 110. According to this exemplary embodiment, the contact area between the horizontal driving circuit portion 104, the ACF 15, and the substrate 110, may increase, thereby enhancing adhesion and completing a more reliable EL display.

The above-described embodiment is an example for describing the present invention, and thus the present invention is not limited thereto. For example, although the upper terminal conductive layer is coupled with the lower terminal conductive layer through the via hole 181′ in FIG. 3B, as shown in FIG. 3D, the layer 190′ (i.e., the upper terminal conductive layer) may be directly formed on the layer 170′ (i.e., the lower terminal conductive layer). Alternatively, as shown in FIG. 3C, the same layer 150′ as the gate electrode 150 may be located below the layers 190′ and 170′ as the lower terminal conductive layer. Further, although the layer 190′ is described as the upper terminal conductive layer in the foregoing embodiments, the present invention is not limited thereto. That is, a second electrode layer may be additionally formed as the upper terminal conductive layer. The present invention may be applied to an ILED, and an AM or PM type display, in addition to the OLED. A recess may be formed in both a substrate and a protective layer, or in a protective layer, an interlayer, and a gate insulating layer. Also, a plurality of terminals may be formed in one recess. As described above, the present invention may be modified in various ways.

According to exemplary embodiments of the present invention, when terminals of a pad portion are bonded to terminals of an electric element by a layer such as an ACF, their contact area may increase by reducing voids when they interlock with each other. Thus, even if the EL display bends, separation between the upper and lower terminals may be minimized, thereby reducing product failure rate and preventing malfunction due to contact failure. Further, the pad portion's terminals may be formed of one or more conductive layers, thus securing reliable conductivity.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An electroluminescent display device, comprising:
a substrate;
a display region formed on the substrate and including a first electrode layer, a second electrode layer, and an emission portion between the first electrode layer and the second electrode layer; and
a pad portion comprising a terminal and located outside the display region,
wherein a recess is formed in a surface of the substrate, and the terminal is located in the recess.

2. The device of claim 1, wherein the terminal comprises an upper terminal conductive layer and a lower terminal conductive layer.

3. The device of claim 2, wherein the upper terminal conductive layer is formed of a same material as at least one of the first electrode layer and the second electrode layer.

4. The device of claim 2,
wherein the display region further comprises a thin film transistor (TFT) coupled with the first electrode layer, and
wherein the lower terminal conductive layer comprises a layer formed of a same material as a source electrode and a drain electrode of the TFT.

5. The device of claim 2,
wherein the display region further comprises a thin film transistor (TFT) coupled with the first electrode layer, and
wherein the lower terminal conductive layer comprises a layer formed of a same material as a gate electrode of the TFT.

6. An electroluminescent display device, comprising:
a substrate;
a display region formed on the substrate and including a first electrode layer, a second electrode layer, an emission portion located between the first electrode layer and the second electrode layer, and a thin film transistor (TFT) coupled with the first electrode layer; and
a pad portion comprising a terminal and located outside the display region,
wherein a layer extending from the display region to the pad portion has a recess, and
wherein the terminal is located in the recess.

7. The device of claim 6, wherein the terminal comprises an upper terminal conductive layer and a lower terminal conductive layer.

8. The device of claim 7, wherein the upper terminal conductive layer is formed of a same material as at least one of the first electrode layer and the second electrode layer.

9. The device of claim 7, wherein the lower terminal conductive layer comprises a layer formed of a same material as a source electrode and a drain electrode of the TFT.

10. The device of claim 7, wherein the lower terminal conductive layer comprises a layer formed of a same material as a gate electrode of the TFT.

11. A method for manufacturing an electroluminescent display device comprising a display region, which is formed on a substrate and includes a first electrode layer, a second electrode layer, and an emission portion located between the first electrode layer and the second electrode layer, and a pad portion, which includes a terminal and is located outside the display region, the method comprising:
forming the pad portion,
wherein forming the pad portion comprises:
forming a recess in a surface of the substrate; and
forming the terminal in the recess.

12. The method of claim 11, wherein forming the terminal comprises:
forming an upper terminal conductive layer; and
forming a lower terminal conductive layer.

13. The method of claim 12, wherein the upper terminal conductive layer is formed when forming at least one of the first electrode layer and the second electrode layer.

14. The method of claim 12,
wherein the electroluminescent display device further comprises a thin film transistor (TFT) coupled with the first electrode layer, and
wherein the lower terminal conductive layer is formed when forming a source electrode and a drain electrode of the TFT.

15. The method of claim 12,
wherein the electroluminescent display device further comprises a thin film transistor (TFT) coupled with the first electrode layer, and
wherein the lower terminal conductive layer is formed when forming a gate electrode of the TFT.

16. A method for manufacturing an electroluminescent display device comprising a display region, which is formed on a substrate and includes a first electrode layer, a second electrode layer, an emission portion located between the first electrode layer and the second electrode layer, and a thin film transistor (TFT) coupled with the first electrode layer; and a pad portion, which includes a terminal and is located outside the display region, the method comprising:
forming the pad portion,
wherein forming the pad portion comprises:
forming a layer extending from the display region to the pad portion;
forming a recess in the layer; and
forming the terminal in the recess.

17. The method of claim 16, wherein forming the terminal comprises:
forming an upper terminal conductive layer, and
forming a lower terminal conductive layer.

18. The method of claim 17, wherein the upper terminal conductive layer is formed when forming at least one of the first electrode layer and the second electrode layer.

19. The method of claim 17, wherein the lower terminal conductive layer is formed when forming a source electrode and a drain electrode of the TFT.

20. The method of claim 17, wherein the lower terminal conductive layer is formed when forming a gate electrode of the TFT.
